(19) United States
(12) Patent Application Publication
(10) Pub. No.: US 2011/0162927 A1
(43) Pub. Date: Jul. 7, 2011

(54) METHOD FOR OPERATING A RETARDER

(76) Inventors: Tilman Huth, Satteldorf (DE); Jürgen Betz, Satteldorf (DE); Roland Scherer, Crailsheim (DE)

(21) Appl. No.: 12/735,364

(22) PCT Filed: Nov. 25, 2009
(86) PCT No.: PCT/EP2009/008379

§ 371 Date: Nov. 12, 2010

(30) Foreign Application Priority Data
Dec. 3, 2008 (DE) 102008060377.5

(51) Int. Cl. F16D 57/00

(52) U.S. Cl. 188/290

(57) ABSTRACT

The invention relates to a method for operating a hydrodynamic retarder having at least one working chamber that is filled with a working medium in braking mode, and substantially emptied in non-braking mode. According to the invention, a prescribed amount of working medium is pulsingly brought into the working chamber of the retarder in non-braking mode. This can occur either constantly, or as a function of suitable measurement variables.

The invention relates to a method for operating a hydrodynamic retarder having at least one working chamber, according to the type defined in greater detail in the preamble of Claim 1.

Using retarders as wear-free retarding brakes, in particular in utility vehicles, is known from the general prior art. The retarders are typically attached directly to a secondary output of an internal combustion engine or a transmission or to a universal shaft of such a vehicle. They are filled with a working medium, typically oil or water and/or a water mixture, for operation. In braking operation, the working medium in the working chamber of the hydrodynamic retarder is set into a circulatory flow by drive of a bladed rotor of the retarder, so that torque from the rotor of the retarder is hydrodynamically transmitted to a bladed stator or a bladed opposing rotor, which results in hydrodynamic braking of the rotor, and the desired braking action of the retarder thus occurs. In non-braking operation, the working chamber of the retarder is essentially or completely emptied, so that no torque is transmitted from the rotor to the stator or the opposing rotor and accordingly no braking action is generated. This generally known and typical construction of a hydrodynamic retarder allows the retarder to be shut down without its rotor having to be disconnected from the drivetrain via switchable interrupting clutches.

During the use of retarders of this type, in particular in utility vehicles, it has sometimes been established that the working chamber of the retarder has leaks in relation to the surroundings or another adjoining installation space. These leaks occur in particular in the area of the seals which seal the working chamber of the retarder to the outside in the area of the rotor shaft. Above all, leaks of this type are to be observed in retarders which are used in vehicles which use the retarders rather seldom in regular operation, in particular in vehicles which are predominantly used in long-haul operation.

The origin of the occurring leaks is unclear, but they are dealt with by a comparatively frequent replacement of the seals used, which is maintenance-intensive and correspondingly costly and time-consuming, however.

These problems are dealt with in DE 10 2005 009 456 A1 in that an appropriate seal of the working chamber in relation to the surroundings is ensured in the area of the rotor shaft via multiple seals connected one behind another. However, this structure has the disadvantage that it has a comparatively complex construction and may not be readily retrofitted in retarders which already exist and are installed in vehicles.

The object of the present invention is to provide a method which correspondingly increases the tightness of an arbitrary retarder or the service life of its seals without having to engage in the construction of the retarder using constructive measures.

This object is achieved according to the invention by the features listed in the characterizing part of Claim 1.

It has surprisingly been shown to the inventors that significantly longer service lives of the seals may be achieved in the case of frequently-used retarders than is the case with little-used retarders. Corresponding experiments have shown that this has to do in particular with the wetting of the seal with the working medium. Correspondingly, it was recognized by the inventors that it is also advantageous in non-operation for the tightness of the retarder if a specified quantity of working medium is repeatedly introduced in a pulsing manner into the working chamber of the retarder. “Pulsing” is to be understood in the meaning of the present invention as a pulsed activation which repeats at time intervals. Any conceivable shapes and sizes of control pulses, such as rectangular pulses, sawtoothed pulses, sinusoidal pulses, semicircular pulses, or the like may come into consideration for generating the pulsing activation. This pulsing introduction of a small quantity of working medium from time to time can accordingly also be understood as a type of lubrication pulse. Such a lubrication pulse introduced over a time pattern keeps the seals of the working chamber appropriately supple and cools them, so that they may fulfill their function over a very long service life and reliably seal the working chamber of the retarder to the outside.

The quantity used for such a lubrication pulse is to be selected as rather small, in order to trigger no or only minimal braking action of the retarder, so that the method according to the invention is finally not disadvantageously noticeable to the driver of a vehicle equipped with the retarder. The quantity of working medium introduced for the lubrication pulse into the retarder is pumped by the retarder itself back out of the working chamber, so that a possibly occurring minimal braking action would only be of very brief duration.

According to one embodiment of the method according to the invention, the retarder can be operated in such a way that the duration of the pulses, the amplitude, and/or the time interval between the pulses is specified. Both a constant time interval, a constant amplitude, and/or a constant duration of the pulses and also a variation of the time interval and/or the amplitude or a varying duration of the pulses are possible. The duration of the pulses may alternatively also be referred to as the duration of the activation of the introduction of working medium into the working chamber.

In a particularly favorable embodiment of the invention, the duration of the pulses, the amplitude, and/or the time interval between the pulses can be changed as a function of the temperature of the working medium and/or another specified variable.

This particularly advantageous variant allows the duration and the number of the required lubrication pulses to be optimized with respect to the operation of the retarder via a very simple temperature measurement, which is easy to implement. Thus, for example, with rising temperature of the working medium, the duration of the pulses, the amplitude, and/or the time interval between the pulses can be adapted so that more frequent and more intensive wetting of the working chamber with the working medium occurs. Viewed over the entire operation, this means that the number of the lubrication pulses can be minimized as a function of the operating parameter “temperature”. The power losses in the retarder which also possibly occur with very small quantities of working medium may thus be minimized still further, as well as the power which is required to introduce the specified quantity of working medium as the lubrication pulse into the working chamber.

Furthermore, according to a very advantageous refinement of the invention, alternatively or additionally to the temperature, the duration of the pulses, the amplitude, and/or the interval between the pulses can be changed as a function of the speed of a rotor of the retarder.

This allows comparable advantages as in the case of the use of the operating parameter “temperature”. Upon a combination of the two operating parameters “temperature” and “rotor speed”, a further optimization can even be achieved.

In addition, according to a very favorable refinement of the invention, it can be provided that the duration of the pulses, the amplitude, and/or the interval between the pulses is/are alternatively or additionally changed as a function of the velocity of a vehicle equipped with the retarder.

This optionally offers the advantage that the value of the velocity of the vehicle is more easily available via a corresponding control unit than the speed of the rotor of the retarder. However, a fixed relationship exists between these two variables if the rotor is coupled via a fixed transmission in the drivetrain of the vehicle, as is typically the case. It is therefore easily possible to use the velocity of the vehicle alternatively to the speed of the rotor, if this velocity is easier to obtain via the corresponding sensor system of the vehicle than is the case for the speed of the rotor. For example, a velocity signal provided via the CAN bus of the vehicle can be used as an input variable to determine the necessity for a lubrication pulse.

In a particularly favorable variant of the invention, it is provided that the pulsing introduction of the working medium into the working chamber only occurs when a specified first limiting temperature of the working medium is exceeded, or a specified limiting speed of the rotor and/or a limiting velocity of the vehicle is exceeded. According to an alternative embodiment, the pulsing introduction of the working medium into the working chamber only occurs in non-braking operation if a specified first limiting temperature of the working medium is exceeded and simultaneously a specified limiting speed of the rotor and/or a limiting velocity of the vehicle is exceeded.

In this embodiment of the invention, the application of the lubrication pulse according to the invention will thus occur only in the operating states in which it is also necessary, namely if a corresponding velocity of the vehicle and/or speed of the rotor indicates a corresponding intensive operation of the retarder and/or the vehicle, and/or if a comparable indication is indicated by exceeding a first limiting temperature of the working medium. If neither of the two conditions exists, the lubrication pulse is dispensed with, so that the expenditure of power and the losses connected thereto may be saved. This embodiment of the method thus contributes to an optimization of the number and/or the duration of the lubrication pulses, which will occur over a longer period of time during the operation of the vehicle and/or the retarder.

A further variable, as a function of which the duration of the pulses, the amplitude, and/or the time interval between the pulses can be changed, is the viscosity and/or the material-dependent lubrication property of the working medium, in particular oil. For example, the duration and/or the amplitude or the time interval can be set as a function of the types of oil used as the working medium. It is also possible to consider that the working medium, in particular oil, ages in the course of the operating time and thus the time interval between the lubrication pulses and/or the duration of the lubrication pulses or their form (such as the amplitude) is to be changed with increasing age of the working medium or with increasing number of activations of the retarder and/or increasing mileage of the vehicle, in particular the time interval is to be shortened and/or the duration or the amplitude is to be increased.

The invention can be used in a particularly advantageous manner in typical oil retarders.

Alternatively thereto, the invention is also usable in retarders which are operated using another working medium, such as water or a water mixture. In particular, the invention is also usable in water retarders which use the cooling water of the vehicle as the working medium, because a longer service life of the seals is also achieved here via a corresponding lubrication pulse using the working medium and wetting of the working chamber thus achieved.

Further advantageous embodiments of the invention result from the remaining subclaims and will become clear on the basis of the exemplary embodiment described hereafter, which is explained with reference to the figures.

In the figures:

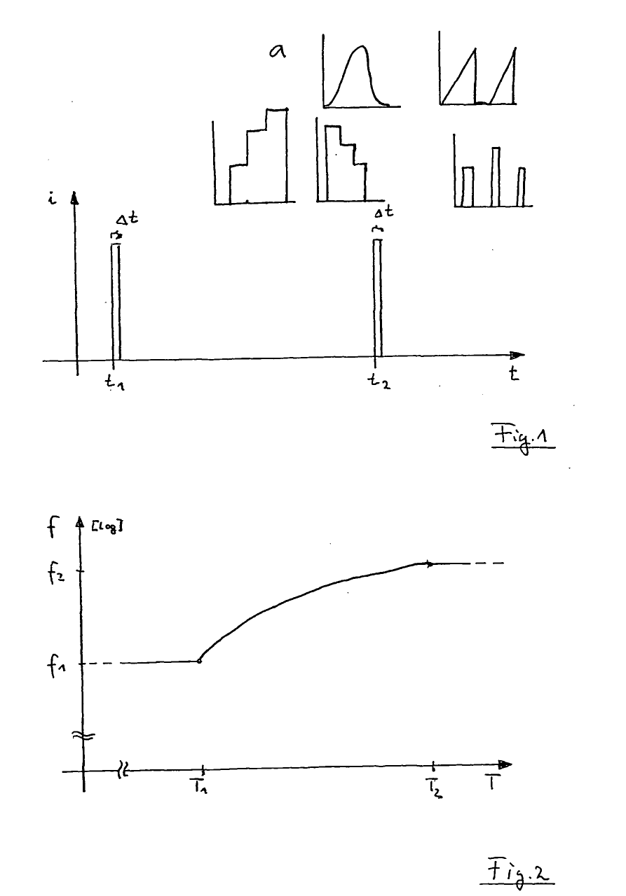

FIG. 1 shows a diagram having a possible variant for performing the method according to the invention; and

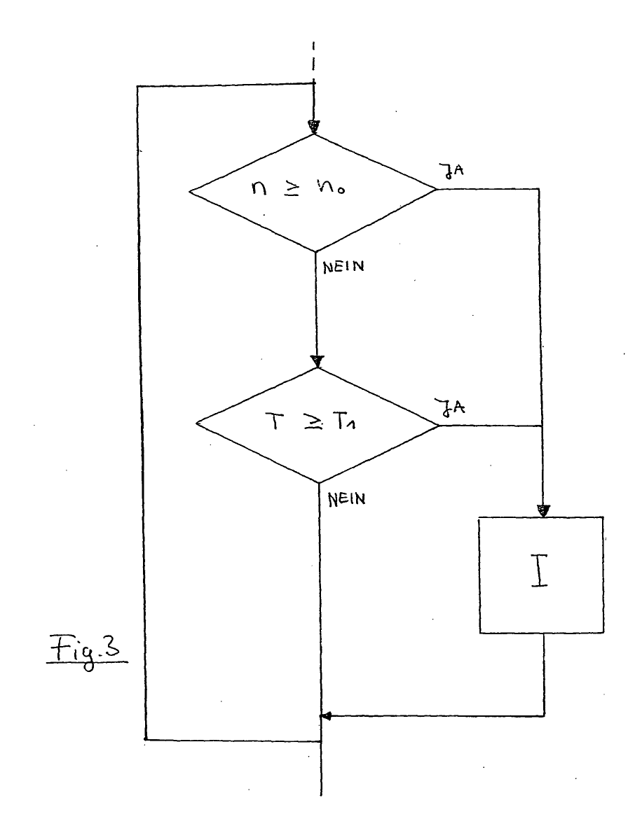

FIG. 2 shows a graph of the frequency of the lubrication pulses over the temperature of the working medium in a further variant of the method according to the invention; and

FIG. 3 shows a flow chart for an alternative variant for performing the method according to the invention.

The operation and the installation of a retarder in the drivetrain of a vehicle as a wear-free retarding brake is normal and typical for a person skilled in the art in the field of retarder technology, so that it will not be discussed in greater detail here in the context of the operating method according to the invention described here. Fundamentally, all constructions of hydrodynamic retarders are possible for the use of the method described hereafter for operating a retarder, whether they use oil or water and/or an aqueous mixture as the working medium.

The way in which the retarder is filled with the working medium for braking operation also plays no role or a subordinate role for the present invention. Fundamentally, it is conceivable and normal to fill the working chamber of the retarder via a suitable line having a valve, such as a solenoid valve, the working medium being located in a corresponding reservoir, in which it is under a higher pressure than the pressure which prevails in the working chamber. As long as the valve is open, the working medium will flow into the working chamber of the retarder. The retarder can typically empty itself again by the movement of the rotor and convey the medium back into the storage chamber.

Alternatively thereto, it would be conceivable to convey the working medium via a corresponding conveyor unit, such as a pump, on demand into the working chamber of the retarder for the braking operation.

The third typical variant comprises storing working medium in a corresponding volume, which is under a comparable pressure as the working chamber of the retarder. This storage volume is situated so that the working medium does not flow automatically into the working chamber of the retarder. In addition, a corresponding movable device, such as a piston or preferably a diaphragm, can be situated in the storage volume. Through a corresponding application of pressure to the side of the diaphragm or the piston facing away from the storage volume, for example, using compressed air, the working medium is pressed out of the storage volume into the working chamber of the retarder, so that very rapid filling of the working chamber of the retarder with the working medium is made possible.

Other filling procedures are conceivable.

In the present method for operating a retarder, it plays a decisive role that a specified quantity of working medium can be introduced in a pulsing manner into the working chamber of the retarder via suitable measures. This could be performed in the first and third above-described variants, for example, in that the solenoid valve between storage volume and working chamber is opened for a brief time duration and/or the pressure application on the side of the diaphragm or the piston facing away from the storage volume is typically also performed via a corresponding valve for a short time. In the second above-described variant, this could be performed by a corresponding brief startup of the conveyor unit in the case of an electrically driven conveyor unit, for example, via a corresponding electrical pulse to the motor of the conveyor unit. Of course, it would also be possible to briefly switch in a filling pump which is disengaged by a clutch or to switch in a filling pump which revolves comparatively slowly because of a provided slip clutch via the clutch. A corresponding changeover on the hydraulic side of the pump, firstly past the retarder and then briefly into the retarder, would also be conceivable.

The various variants for implementing a brief pulsed (pulsing) introduction of working medium into the working chamber of a retarder via a corresponding pulse are obvious to a person skilled in the art and may be expanded accordingly to variants other than those described up to this point. For the method according to the invention, this concrete implementation is of subordinate significance, however, because only the fact that such a lubrication pulse is triggered, and the quantities of working medium which it introduces into the retarder in which operating states are of corresponding significance for the invention.

A first variant for a lubrication pulse according to the invention of this type is shown in the graph of FIG. 1. As soon as the retarder is not in braking operation, corresponding pulses are transmitted to a valve or the electric motor of a conveyor unit, for example, in order to allow a corresponding pulsing introduction of working medium into the working chamber of the retarder. In the graph of FIG. 1, an exemplary embodiment is shown in which a corresponding pulse of a particular constant pulse duration Δt of approximately 50 to 250 ms, particularly preferably in the magnitude of approximately 100 ms, is initiated. The rectangular pulses selected as an example in the graph of FIG. 1 are only one possible example.

Alternatively thereto, other pulse shapes would be conceivable, such as sawtoothed, sinusoidal, trapezoidal, semicircular, or other shaped pulses. Through this pulse, working medium is thus introduced for a very brief time into the working chamber of the retarder. The working medium is specified in its quantity by the duration of the pulse. In the typical construction of retarders having a working chamber volume of approximately 3 to 9 L, quantities of 50 to 100 mL are entirely adequate. Less than 5%, preferably less than 2%, of the filling quantity of working medium in braking operation is thus typically introduced as the lubrication pulse. This comparatively small quantity of working medium prevents a braking action and/or a braking action which is perceptible to the driver of a vehicle of this type from occurring. The quantity is nonetheless sufficient to be swirled by the rotor of the retarder so that a corresponding wetting of the working chamber of the retarder and in particular the areas having the seals is achieved here. Through this pulsing wetting of the seals when the retarder is in non-braking operation, a correspondingly longer service life of the seals and a better seal of the retarder are achieved.

An operating method is shown as an example in the graph of FIG. 1, which is not to scale, in which a specific current I, plotted here on the y axis, is conducted in specific pulses to a valve, in order to open it. This in turn ensures that working medium can reach the working chamber during the pulsed opening of the valve. In the operating method shown in FIG. 1, constant pulse durations Δt in the above-mentioned magnitude are used, which are triggered at constant time intervals (t₂−t₁). Using this very simple and efficient method, whenever the retarder runs in non-braking operation, a lubrication pulse can thus be introduced in a pulsing manner into the working chamber. For example, pulse durations of approximately 100 ms and an interval between the pulses in the magnitude of 10 to 250 seconds, preferably in the magnitude of approximately 60 to 120 seconds, are selected here.

In graph a of FIG. 1, further pulse shapes for the pulsing introduction of working medium into the working chamber in non-braking operation of the retarder are shown as examples. In the present case, a type of sinusoidal curve or an arched curve and a sawtoothed curve and also individual rectangular pulses having varying or alternating amplitude are shown only as selected possible examples of the pulse shape. Instead of the sawtoothed curve, a chronologically stepped increasing curve and/or chronologically stepped decreasing curve of the amplitude may also be possible. Other pulse shapes are, of course, conceivable to provide the pulsing introduction according to the invention.

A further diagram is shown in FIG. 2, in which the frequency f of the lubrication pulses is shown as the time interval between the individual lubrication pulses on a logarithmic scale. In this method, a constant pulse duration Δt is also to be used, because this is to be provided in a particularly simple and efficient manner, and a uniform specified quantity of working medium always reaches the working chamber thereby, which can be selected by the selection of the duration of the lubrication pulse depending on the employed retarder, so that the quantity corresponds to the above-mentioned quantity specifications, so as not to cause an undesired braking action of the retarder by the lubrication pulse.

The temperature T of the working medium of the retarder is shown as an example on the x axis in the exemplary embodiment shown in FIG. 2. It is to be noted that up to a first limiting temperature T₁, a constant duration is implemented between the individual lubrication pulses, for example, in a magnitude of approximately 180 seconds, which results in the corresponding frequency f₁. With increasing temperature of the working medium above the first limiting temperature T₁, the frequency rises linearly between the individual lubrication pulses, for example. Through the logarithmic plotting of the frequencies on the y axis, this linear rise is indicated here by a corresponding logarithmic curve. This linear rise occurs up to a second limiting temperature T₂ of the working medium. Above this second limiting temperature T₂, a constant duration is again specified between the individual lubrication pulses. Because the limiting temperature T₂ is typically selected in the upper range of the temperatures occurring in a retarder, the frequency of the lubrication pulses is already relatively high here, for example, durations between the individual lubrication pulses may be in the magnitude of 10 seconds. The appropriate linear curve for the lubrication pulses is selected between these two frequencies, which deviate from one another by a factor of 15 to 25, in particular 15 to 20, in the typically occurring operating case of the retarder at temperatures between the limiting temperature T₁ and the second limiting temperature T₂. Instead of the linear curve, other relationships are also conceivable, for example, a stepped curve, a quadratic curve, a logarithmic curve, or the like. Other factors are also conceivable, of course.

Alternatively to employing the temperature of the working medium in order to detect the load of the retarder and control the frequency of the lubrication pulses accordingly, it would also be conceivable that the frequency of the lubrication pulses is varied as a function of other variables, for example, as a function of the speed of the rotor or, in that this is simpler to measure, as a function of the driving velocity of the vehicle equipped with the retarder, because, in the case of a corresponding fixed transmission in the incorporation of the retarder of the drivetrain, it is proportional to the speed of the rotor of the retarder. In the case of a primary retarder, the engine speed would also be usable, for example. In general, any variable or speed can be used from which the speed of the driven rotor of the retarder can be concluded, and which is particularly proportional thereto.

Of course, the values may also be combined with one another accordingly. A variant is particularly advisable which establishes via a corresponding speed or velocity whether the use of lubrication pulses is required at all, before they are activated accordingly.

FIG. 3 shows such a comparatively complex strategy for controlling lubrication pulses in a flowchart. Firstly, in this strategy, it is checked whether the speed of the rotor n is above a specified limiting speed nₒ. Alternatively thereto, a corresponding check of the running velocity of the vehicle, which is typically proportional to the speed of the rotor in the case of a secondary retarder, would also be conceivable. As soon as the speed n of the rotor is above the specified limiting speed nₒ, a lubrication pulse is initiated by a corresponding controller, which is to be symbolized here by the square box having the designation I. This lubrication pulse can be the lubrication pulse explained in detail in the context of FIG. 2, for example.

If the corresponding speed n of the rotor is not above the limiting speed nₒ, a corresponding temperature measurement of the temperature of the working medium is nonetheless analyzed. If this temperature T is above the first limiting temperature T₁, a corresponding activation of the program for the lubrication pulses I is also started. The program described in detail in FIG. 2 can also be used here, of course, the part having constant interval between the lubrication pulses below the limiting temperature T₁ being dispensed with here, because the program is accordingly only started when the limiting temperature T₁ already exists. If the limiting temperature T₁ does not exist, the temperature T of the working medium is thus below this limiting temperature T₁, and the program is thus terminated at this point, without the corresponding lubrication pulses being activated.

The measurements of the speed or the velocity and the temperature advantageously occur continuously or at specified intervals, so that a reaction can be performed accordingly if one of the values rises above its specified limiting value.

The sequence of the method described here is particularly efficient, because it only activates lubrication pulses for the retarder when they are also absolutely necessary, specifically whenever the speed of the rotor is above a corresponding limiting speed or, alternatively thereto, if a corresponding high temperature exists in the working medium of the retarder, i.e., whenever the retarder is loaded correspondingly. The activation of the lubrication pulses can be specified by a corresponding constant specification similar to the graph in FIG. 1, or a corresponding “intelligent” controller can be used, which also in turn provides a corresponding variation of the frequency f of the lubrication pulses as a function of other measured values here, such as the speed of the rotor or the vehicle velocity, and thus allows a lubrication of the retarder which is optimally adapted to the operating state thereof.

Alternatively thereto, it would also be conceivable not to adapt the frequency f of the lubrication pulses, but rather the length or pulse duration Δt according to the load state of the retarder, for example, as a function of the temperature and/or the rotor speed or the vehicle velocity. Because the quantity of the working medium used for the lubrication pulse is always connected to the problems of the occurrence of a possible braking action, however, the control effort for this variant is correspondingly higher.

Is also conceivable to provide a learning control unit, in particular an electronic control unit (ECU), which recognizes a use profile or a driver behavior and specifies the lubrication pulse, in particular the duration and/or the interval between the individual pulses, as a function of the detected use profile or the detected driver behavior. Of course, it is fundamentally true that the amplitude can also be adapted, in order to establish the injection quantity of each pulse together with the pulse duration.

Finally, some exemplary values are to be listed, so that it is comprehensible in which ranges the method for operating the retarder moves. Thus, for example, temperatures between 100° C. and 140° C., preferably approximately 120° C., can be used as the first limiting temperature for an oil-operated retarder, and temperatures between 150° C. and 200° C., preferably approximately 180° C., can be used for the second limiting temperature. For a water retarder, the temperatures decrease accordingly, so that typically a first limiting temperature will be in the magnitude of 100° C. to 110° C., preferably approximately 105° C., while the second limiting temperature is in the magnitude of 110° C. to 120° C., in particular at approximately 112° C. to 115° C.

Typical pulse durations are, as already described above, in a magnitude of 50 to 250 ms, largely independently of the working medium, so that typically less than 5%, preferably less than 2% of the filling quantity of the working chamber in braking operation, reaches the working chamber of the retarder as lubrication pulse.

The construction allows the corresponding operating method to be retrofitted using a simple adaptation of the controller even in already existing systems. For the operator of a vehicle equipped with the retarder, this operating method will not be noticeable, however, he will be rewarded with a longer service life of the seals of the retarder and/or a better seal of the retarder.

1-13. (canceled)

14. A method for operating a hydrodynamic retarder having at least one working chamber, which:
is filled with a working medium in braking operation, and
is essentially emptied in non-braking operation,
characterized in that
a specified quantity of working medium is introduced in a pulsing manner into the working chamber of the retarder in non-braking operation.

15. The method according to claim 14, characterized in that the duration (Δt) of the pulses, the amplitude, and/or the time interval (t₂−t₁) between the pulses is changed as a function of the temperature (T) of the working medium.

16. The method according to claim 14, characterized in that the duration (Δt) of the pulses, the amplitude, and/or the time interval (t₂−t₁) between the pulses is changed as a function of the speed (n) of a rotor of the retarder.

17. The method according to claim 14, characterized in that the duration (Δt) of the pulses, the amplitude, and/or the time interval (t₂−t₁) between the pulses is changed as a function of the velocity of a vehicle equipped with the retarder.

18. The method according to claim 14, characterized in that the duration (Δt) of the pulses, the amplitude, and/or the time interval (t₂−t₁) between the pulses is changed as a function of the temperature (T) of the working medium and either the velocity of a vehicle equipped with the retarder or the speed (n) of a rotor of the retarder.

19. The method according to claim 14, characterized in that the duration (Δt) of the individual pulses and in particular the amplitude is kept constant, and the time interval (t₂−t₁) between the individual pulses is changed.

20. The method according to claim 14, characterized in that the pulsing introduction of the working medium into the working chamber only occurs,
if a specified first limiting temperature (T₁) of the working medium is exceeded; and/or
if a specified limiting speed (nₒ) of the rotor of the retarder and/or a specified limiting velocity of the vehicle is exceeded.

21. The method according to claim 14, characterized in that the time interval (t₂−t₁) between the pulses is selected as constant at a first value below a first limiting temperature (T₁), furthermore, the time interval (t₂−t₁) between the pulses is selected as greater, in particular rising steadily, with increasing temperature between the first limiting temperature (T₁) and a second limiting temperature (T₂), which is greater than the first limiting temperature (T₁), and the duration (t₂−t₁) between the pulses is kept constant at a second value above the second limiting temperature (T₂).

22. The method according to claim 21, characterized in that the first value is 15 to 20 times the second value.

23. The method according to claim 14, characterized in that less than 10%, preferably less than 5% or 2% of the filling quantity of the working medium in the working chamber in braking operation is selected as the specified quantity.

24. The method according to claim 14, characterized in that the pulse duration (Δt) is selected having a length of 50-250 ms, preferably 60-120 ms.

25. The method according to claim 14, characterized in that oil is used as the working medium.

26. The method according to claim 14, characterized in that water or an essentially aqueous mixture, in particular the cooling water of a vehicle equipped with the retarder, is used as the working medium.

27. The method according to claim 15, characterized in that the duration (Δt) of the pulses, the amplitude, and/or the time interval (t₂−t₁) between the pulses is changed as a function of the speed (n) of a rotor of the retarder.

28. The method according to claim 15, characterized in that the duration (Δt) of the pulses, the amplitude, and/or the time interval (t₂−t₁) between the pulses is changed as a function of the velocity of a vehicle equipped with the retarder.

29. The method according to claim 16, characterized in that the duration (Δt) of the pulses, the amplitude, and/or the time interval (t₂−t₁) between the pulses is changed as a function of the velocity of a vehicle equipped with the retarder.

30. The method according to claim 27, characterized in that the duration (Δt) of the pulses, the amplitude, and/or the time interval (t₂−t₁) between the pulses is changed as a function of the velocity of a vehicle equipped with the retarder.

31. The method according to claim 15, characterized in that the duration (Δt) of the individual pulses and in particular the amplitude is kept constant, and the time interval (t₂−t₁) between the individual pulses is changed.

32. The method according to claim 16, characterized in that the duration (Δt) of the individual pulses and in particular the amplitude is kept constant, and the time interval (t₂−t₁) between the individual pulses is changed.

33. The method according to claim 15, characterized in that the pulsing introduction of the working medium into the working chamber only occurs,
if a specified first limiting temperature (T₁) of the working medium is exceeded; and/or
if a specified limiting speed (nₒ) of the rotor of the retarder and/or a specified limiting velocity of the vehicle is exceeded.
